(19) United States
(12) Patent Application Publication
(10) Pub. No.: US 2011/0085342 A1
(43) Pub. Date: Apr. 14, 2011

(54) HEAT DISSIPATING DEVICE FOR LIGHTING MODULE

(76) Inventors: Alex HORNG, Kaohsiung (TW); Masaharu Miyahara, Kaohsiung (TW); Ssu-Hao Lai, Kaohsiung (TW)

(21) Appl. No.: 12/579,101

(22) Filed: Oct. 14, 2009

(51) Int. Cl. F21V 29/00

(52) U.S. Cl. 362/382

(57) ABSTRACT

A heat dissipating device for a lighting module includes a frame having connecting portions and assembling portions each interconnected between two adjacent connecting portions. Each end of each connecting portion is connected to an adjacent assembling portion. A plurality of air-guiding members is located on the same side of the frame and each mounted on one of the connecting portions. Each air-guiding member includes an air guiding channel having an opening in each end thereof. Each of several heat dissipating fans is mounted to one of the assembling portions and located between two adjacent openings respectively of two adjacent air-guiding members. Each heat dissipating fan includes a first air guiding hole in communication with an environment and at least one second air guiding hole in communication with the two adjacent openings. The air guiding channels and the heat dissipating fans together form a cycling air channel.

### BACKGROUND OF THE INVENTION

1. Field of the Invention

The present invention relates to a heat dissipating device and, more particularly, to a heat dissipating device for a lighting module that generates high heat during lighting.

2. Description of the Related Art

Conventional lighting modules such as lights, backlight modules, or other devices capable of radiating light are liable to generate high heat during operation. A heat dissipating device is generally mounted to the lighting modules for prolonging the service life by dissipating the heat generated by the lighting modules.

Taiwan Utility Model No. M339636 discloses a heat dissipating assembly mounted to a lamp including a lamp body to which a plurality of light-emitting diodes and a shield are mounted. A plurality of heat sinks is mounted to the lamp body to rapidly dissipate the heat generated by the light-emitting diodes during operation. However, the heat sinks may overheat due to lack of auxiliary heat dissipating devices providing rapid heat exchange. Thus, the overall heat dissipating effect of the lamp is adversely affected, leading to shortening of the service life of the lamp.

Liquid crystal displays generally include a backlight module providing a backlight source to provide the liquid crystal displays with display function. The backlight module for the liquid crystal displays can be generally classified into direct-light type and side-light type, both of which must be provided with a heat dissipating device to assure normal operation of the backlight module.

FIG. 1 shows a heat dissipating device 7 for a direct-light type backlight module of a liquid crystal display. The heat dissipating device 7 includes a heat sink 71 and a backlight module 72. A plurality of fins 711 is formed on a side of the heat sink 71. A heat dissipating channel 712 is formed between two adjacent fins 711. The other side of the heat sink 71 is mounted to the backlight module 72 and includes a plurality of light sources 721. The heat generated by the light sources 721 during operation can be dissipated by the heat fins 711 and the heat dissipating channel 712 to prolong the service life of the backlight module 72. However, hot air currents remain inside the liquid crystal display, adversely affecting the heat dissipating effect.

FIG. 2 shows a heat dissipating device 8 mounted to an outer side of a light guide plate of a side-light type backlight module. The heat dissipating device 8 includes a heat conducting pipe unit 81 and a heat sink 82 coupled to the heat conducting pipe unit 81. The heat conducting pipe unit 81 includes at least one heat conducting pipe 811 receiving a heat-conducting medium. A plurality of light-emitting diodes 83 can be mounted to the heat pipe 811. The heat generated by the light-emitting diodes 83 during operation can be transferred to the heat sink 82 via the heat conducting pipe unit 81 for heat dissipating purposes. However, the heat sink 82 occupies a considerable space, leading to difficulties in miniaturization of the liquid crystal display. Furthermore, hot air currents can only be exhausted through the heat conducting pipe unit 81 and heat sink 82, and thus the hot air easily remains inside the liquid crystal display, adversely affecting the heat dissipating effect. Further, the heat-conducting medium must be filled into the heat conducting pipe unit 81 before use, leading to inconvenience in manufacture and use.

FIG. 3 shows another heat dissipating device 9 for a side-light type backlight module. The heat dissipating device 9 includes a frame 91 made of aluminum and a plurality of fins 92 formed along an outer periphery of the frame 91. A plurality of light-emitting diodes 93 can be mounted to an inner periphery of the frame 91. The heat generated by the light-emitting diodes 93 during operation can be transferred to the fins 92 via the frame 91 for heat dissipating purposes. An example of such a heat dissipating device is disclosed in Taiwan Utility Model No. M294189. However, hot air currents remain inside the liquid crystal display, adversely affecting the heat dissipating effect. Furthermore, the frame 91 and the fins 92 occupy a smaller space than that of the heat sink 82 of FIG. 2 at the cost of less efficient heat dissipation due to a smaller area for heat exchange. Namely, the heat dissipating effect in conventional heat dissipating devices depends on the heat-exchange area.

### SUMMARY OF THE INVENTION

An objective of the present invention is to provide a heat dissipating device for a lighting module with improved heat dissipating effect and without the disadvantages of conventional heat dissipating devices.

Another objective of the present invention is to provide a heat dissipating device for a lighting module that can effectively transfer the heat generated by the lighting module during operation to the environment.

A further objective of the present invention is to provide a heat dissipating device for a lighting module that occupies a smaller space in the lighting module.

The present invention fulfills the above objectives by providing, in a preferred form, a heat dissipating device for a lighting module including a frame having a plurality of assembling portions and a plurality of connecting portions. Each of the assembling portions is interconnected between two adjacent connecting portions. Each of the connecting portions includes first and second ends. Each of the first and second ends of each of the connecting portions is interconnected to an adjacent assembling portion. The heat dissipating device further includes a plurality of air-guiding members each mounted on a side of one of the plurality of connecting portions. The plurality of air-guiding members is located on the same side of the frame. Each of the air-guiding members includes an air guiding channel in a side thereof and extending from the first end through the second end of one of the plurality of connecting portions. Each of the air guiding channels includes two ends each having an opening. The heat dissipating device further includes a plurality of heat dissipating fans each mounted to one of the plurality of assembling portions of the frame and located between two adjacent openings respectively of two adjacent air-guiding members. Each of the heat dissipating fans includes a first air guiding hole in communication with an environment and at least one second air guiding hole in communication with the two adjacent openings. The air guiding channels of the plurality of air-guiding members and the plurality of heat dissipating fans together form a cycling air channel.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a conventional heat dissipating device for a direct-light type backlight module.

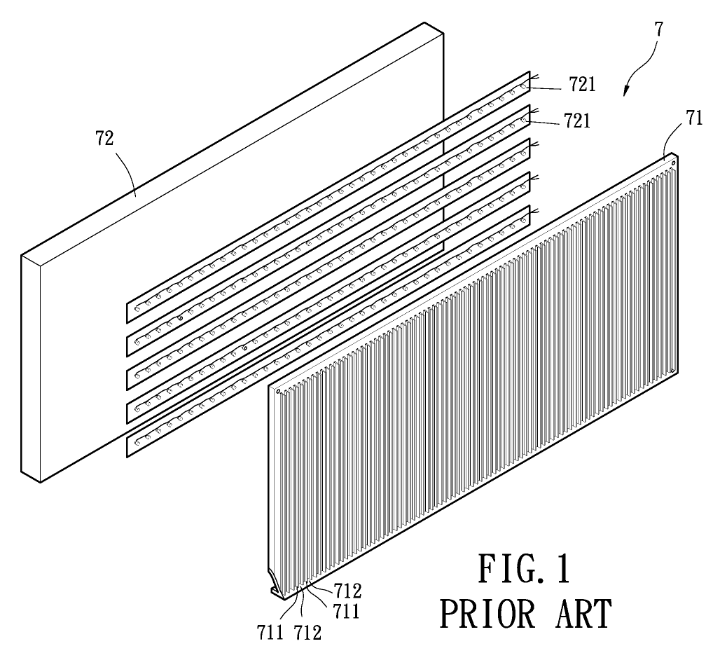

FIG. 2 shows a perspective of a conventional heat dissipating device for a side-light type backlight module.

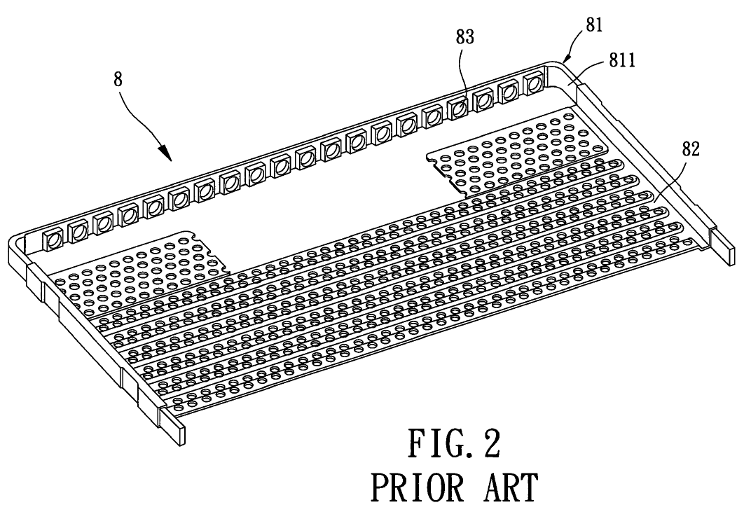

FIG. 3 shows an elevational view of another conventional heat dissipating device for a side-light type backlight module.

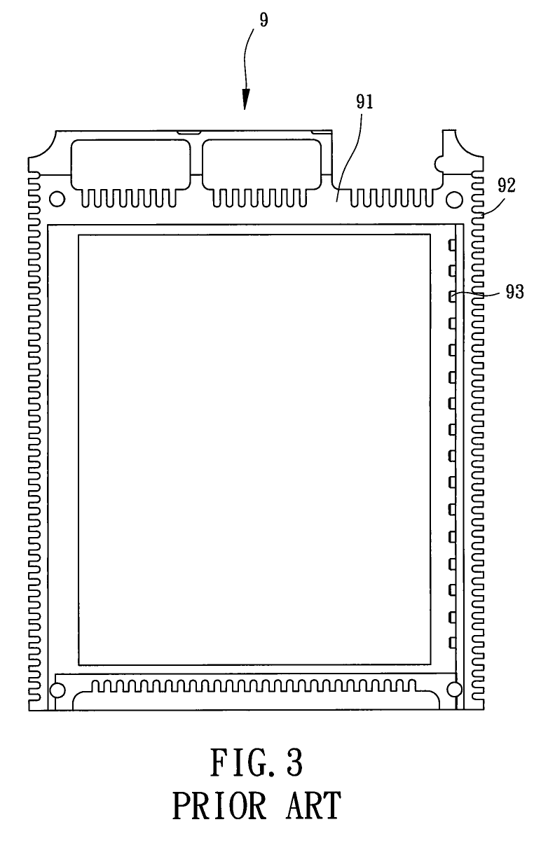

FIG. 4 shows a cross sectional view of a heat dissipating device for a lighting module according to the preferred teachings of the present invention.

FIG. 5 shows a partial, exploded, perspective view of the lighting module according to the preferred teachings of the present invention of FIG. 4.

FIG. 6 shows a partial, exploded, perspective view of a lighting module according to the preferred teachings of the present invention utilizing axial-flow type heat dissipating fans.

FIG. 7 shows a partial, cross sectional view of the lighting module of FIG. 6.

FIG. 8 shows a partial, exploded, perspective view of a lighting module according to the preferred teachings of the present invention utilizing fins.

FIG. 9 shows a partial, exploded, perspective view of a lighting module according to the preferred teachings of the present invention utilizing closure members.

FIG. 10 shows a partial, exploded, perspective view of a lighting module according to the preferred teachings of the present invention utilizing an outer wall.

FIG. 11 shows a cross sectional view of a lighting module according to the preferred teachings of the present invention utilizing two heat dissipating fans.

FIG. 12 is a cross sectional view illustrating an operation mode of the lighting module of FIG. 4.

FIG. 13 is a cross sectional view illustrating another operation mode of the lighting module of FIG. 4.

FIG. 14 is a cross sectional view illustrating operation of a lighting module according to the preferred teachings of the present invention utilizing axial-flow type heat dissipating fans.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “upper”, “inner”, “outer”, “end”, “portion”, “axial”, “cycling”, “clockwise”, “counterclockwise”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A heat dissipating device according to the preferred teachings of the present invention can be utilized in a lighting module such as a light, a backlight module, or any device capable of radiating light. The heat dissipating device according to the preferred teachings of the present invention can dissipate heat generated by the lighting module during operation to prolong the service life of the lighting module. The lighting module will be described using a backlight module as an example to assist in understanding of the objectives, features, and advantages of the heat dissipating device according to the preferred teachings of the present invention.

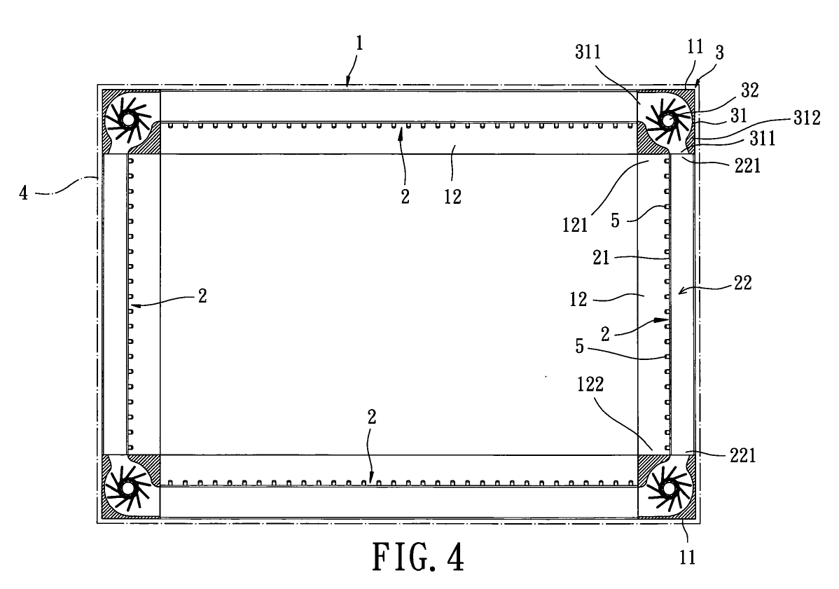

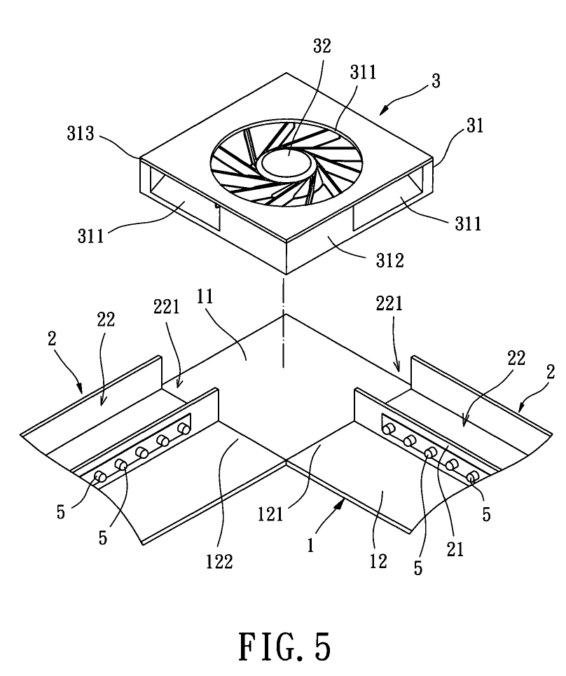

With reference to FIGS. 4 and 5, the heat dissipating device according to the preferred teachings of the present invention includes a frame 1, a plurality of air-guiding members 2, and a plurality of heat dissipating fans 3. The frame 1 is adapted to be coupled to a predetermined location such as a side of a light guide plate of a liquid crystal display (LCD) 4. Each air-guiding member 2 is mounted to the frame 1. A plurality of light sources 5 (such as light-emitting diodes) is mounted to each air-guiding member 2. Each heat dissipating fan 3 is mounted between two adjacent ones of the air-guiding members 2 to guide air currents to flow through the air-guiding members 2 for dissipating the heat generated by the light sources 5.

Specifically, the frame 1 includes a plurality of assembling portions 11 and a plurality of connecting portions 12. The frame 1 is preferably made of heat conductive material. Each assembling portion 11 is interconnected between two adjacent connecting portions 12. Each connecting portion 12 includes first and second ends 121 and 122. Each of the first and second ends 121 and 122 of each connecting portion 12 is interconnected to an adjacent assembling portion 11. The frame 1 can be utilized in various lighting module such as the LCD 4 shown in the drawings. The shape of the frame 1 can be varied according to needs. In the preferred form shown in FIGS. 4 and 5, the frame 1 is rectangular and includes four assembling portions 11 and four connecting portions 12 connected to the four assembling portions 11 that are located in four corners of the rectangular frame 1.

Each air-guiding member 2 is mounted on one of the connecting portions 12. All of the air-guiding members 2 are formed on the same side of the frame 1. Each air-guiding member 2 further includes a heat sink 21 having a side with an air guiding channel 22 extending from the first end 121 through the second end 122 of one of the connecting portions 12 on which the air-guiding member 2 is mounted. Each air guiding channel 22 includes two ends each having an opening 221. In the preferred form shown in FIGS. 4 and 5, four air-guiding members 2 are respectively formed on the four connecting portions 12 and located on the same side of the frame 1. The air-guiding members 2 can be integrally formed with or detachably mounted to the connecting portions 12 with each opening 221 of the air guiding channel 22 of each air-guiding member 2 aligned with one of the assembling portions 11 of the frame 1.

Each heat dissipating fan 3 is mounted in one of the assembling portions 11 of the frame 1 by bonding, welding, screwing, or any suitable provision. Each heat dissipating fan 3 is located between two adjacent openings 221 respectively of the air guiding channels 22 of two adjacent air-guiding members 2. Each heat dissipating fan 3 includes a housing 31 having a plurality of air guiding holes 311. At least one of the air guiding holes 311 serves as an air inlet, and the remaining air guiding holes 311 serve as air outlets. Each air guiding hole 311 of each heat dissipating fan 3 is in communication with the air guiding channels 22 of two adjacent air-guiding members 2 between which the heat dissipating fan 3 is mounted. Furthermore, each heat dissipating fan 3 includes an impeller 32 in the housing 31 for guiding air currents to flow through the air guiding holes 311. The number of the heat dissipating fans 3 of the heat dissipating device according to the teachings of the present invention can be varied according to needs and preferably corresponds to the number of the assembling portions 11 of the frame 1. In the preferred form shown in FIGS. 4 and 5, four heat dissipating fans 3 are respectively coupled to the four assembling portions 11 of the frame 1.

The heat dissipating device according to the teachings of the present invention can utilize heat dissipating fans 3 of different types such as blower type heat dissipating fans or axial-flow type heat dissipating fans.

In the preferred form shown in FIG. 5, the heat dissipating fans 3 are blower type heat dissipating fans. Specifically, the housing 31 of each heat dissipating fan 3 includes a lateral wall 312 having two air guiding holes 311 respectively aligned with two adjacent openings 221 of two adjacent air-guiding members 2. An upper cover 313 is mounted to the lateral wall 312 and includes an air guiding hole 311 in communication with the environment. The air guiding holes 311 of the lateral wall 312 can serve as air outlets, and the air guiding hole 311 of the upper cover 313 can serve as an air inlet. Thus, the heat dissipating device according to the teachings of the present invention can provide a variety of heat dissipating mechanisms. The sizes of the air guiding holes 311 of the lateral wall 312 can be different. In the preferred form shown in FIGS. 4 and 5, the air guiding hole 311 of the lateral wall 312 having a larger size faces a longer air guiding channel 22, and the air guiding hole 311 of the lateral wall 312 having a smaller size faces a shorter air guiding channel 22. Thus, a more uniform heat dissipating effect can be provided when the heat dissipating device according to the teachings of the present invention is utilized in an LCD 4 having a wide screen.

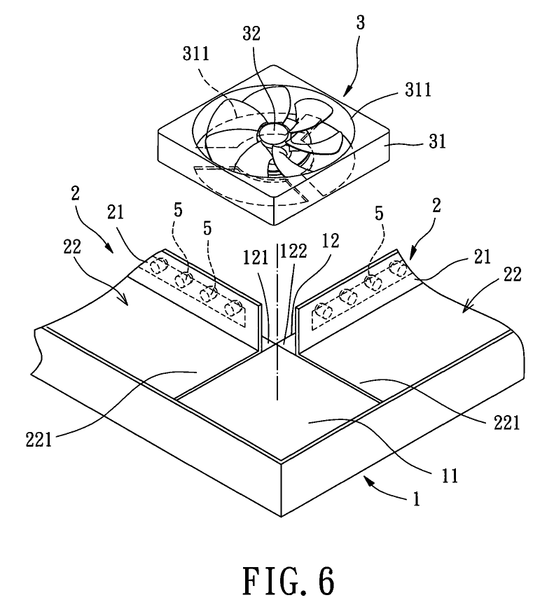

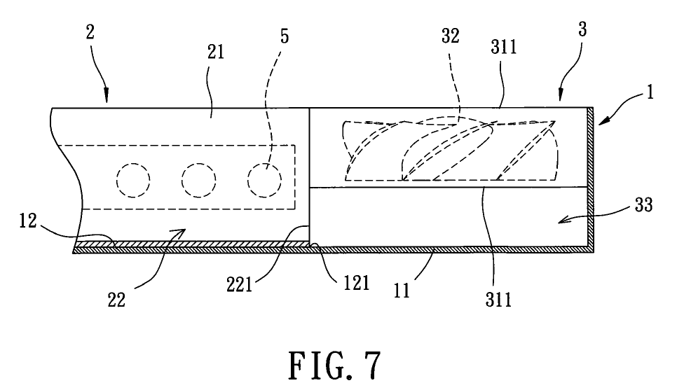

In a preferred form shown in FIGS. 6 and 7, the heat dissipating fans 3 are axial-flow type heat dissipating fans. Specifically, the housing 31 of each heat dissipating fan 3 includes two air guiding holes 311 spaced along a rotating axis of the impeller 32. One of the air guiding holes 311 serves as an air inlet, and the other air guiding hole 311 serve as an air outlet. An inner one of the air guiding holes 311 is in communication with two adjacent openings 221 of two adjacent air-guiding members 2. An outer one of the air guiding holes 311 is in communication with the environment. An air passageway 33 is formed between the housing 31 of each heat dissipating fan 3 and one of the assembling portions 11 of the frame 1. In operation, the air currents created by the impeller 32 can flow into the air guiding channels 22 of the air-guiding members 2 via the air passageways 33 of the heat dissipating fans 3.

The frame 1 and the air-guiding members 2 of the heat dissipating device according to the teachings of the present invention can include other features that can be utilized independently or in combination together with the blower type heat dissipating fans or axial-flow type heat dissipating fans for various heat dissipating functions.

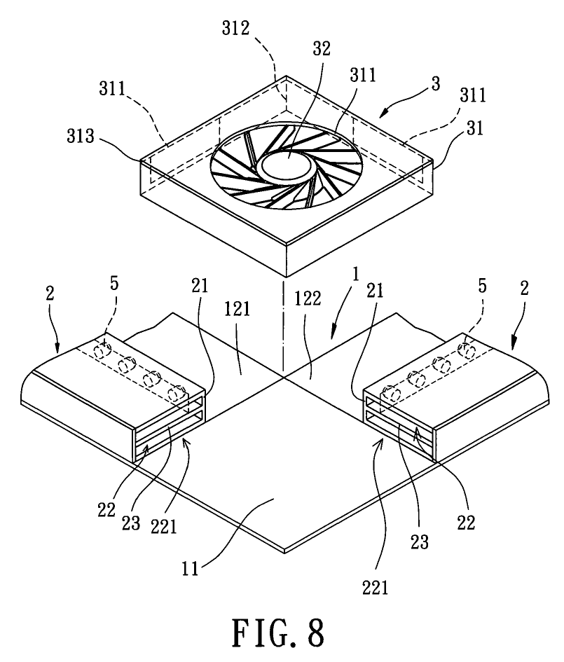

In a preferred form shown in FIG. 8, a plurality of fins 23 can be formed on a side of the heat sink 21 of each air-guiding member 2 and located in the air guiding channel 22. The fins 23 preferably extend perpendicularly to the heat sink 21 to enhance the overall heat dissipating effect by utilizing the fins 23 that increase the overall heat dissipating area.

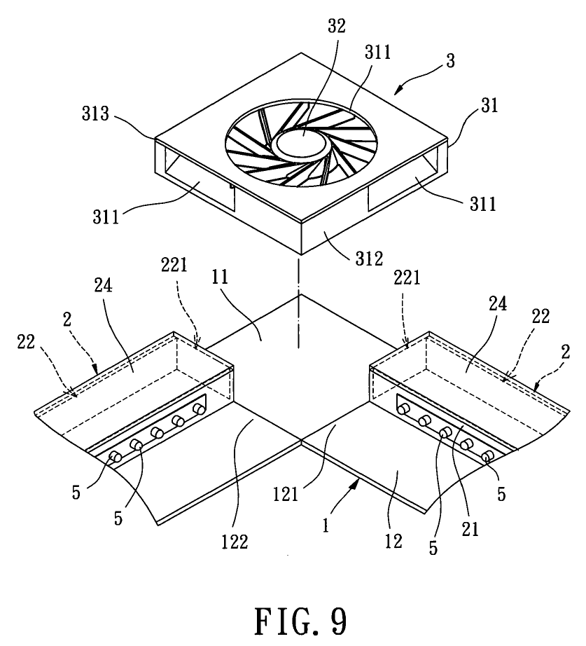

In a preferred form shown in FIG. 9, a closure member 24 is coupled to the heat sink 21 to seal the air guiding channel 22 of each air-guiding member 2. Thus, the air currents guided into the air guiding channels 22 will not exit to the environment via portions other than the openings 221. The air currents can reliably transfer the heat from the heat sinks 21 to the environment, enhancing the heat dissipating effect of the heat dissipating device according to the preferred teachings of the present invention.

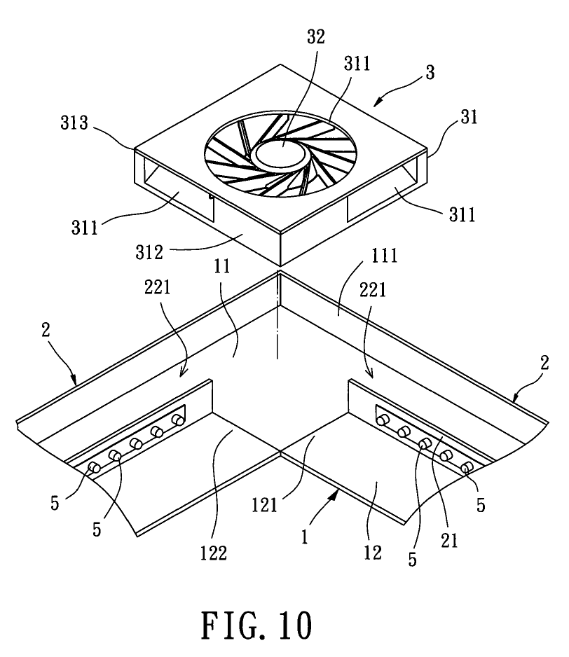

In a preferred form shown in FIG. 10, each assembling portion 11 of the frame 1 includes an outer wall 111. Each heat dissipating fan 3 abuts with the outer wall 111 of one of the assembling portions 11 to increase the coupling stability between the assembling portion 11 and the heat dissipating fan 3.

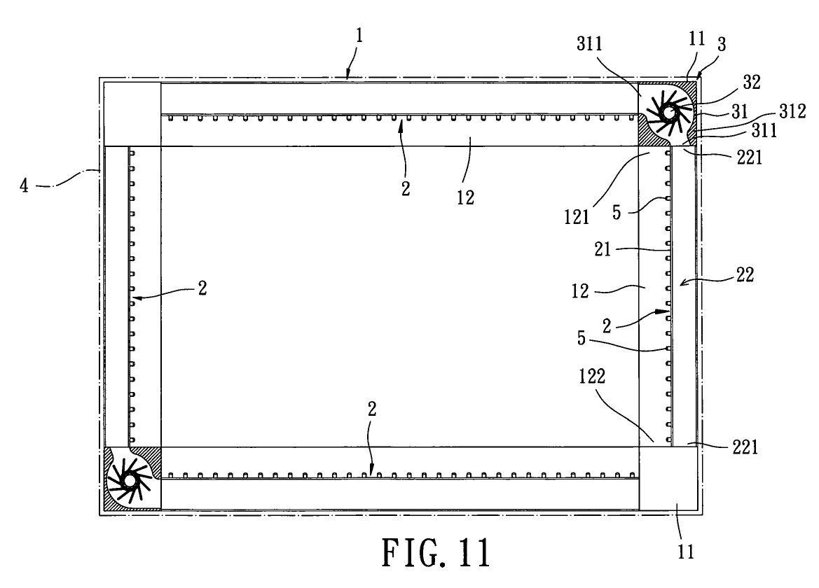

In the preferred form shown in FIG. 11, only two heat dissipating fans 3 are utilized and located on two diagonal corners of the frame 1. The manufacturing cost of the heat dissipating device according to the teaching of the present invention can be cut while achieving certain heat dissipating effect.

In use, the frame 1 of the heat dissipating device according to the teaching of the present invention is coupled to a predetermined portion (such as a light source portion of a lamp or a backlight module). In the preferred forms shown in FIGS. 4 through 11, the frame 1 is coupled to the LCD 4 with the light sources 5 coupled to the heat sink 21 of each air-guiding member 2, with the air guiding channel 22 on a side of the heat sink 21, and with the light sources 5 on the other side of the heat sink 21. Since the openings 221 of the air guiding channels 22 of each air-guiding member 2 are in communication with the air guiding holes 311 of the housings 31 of the heat dissipating fans 3, the air guiding channels 22 and the heat dissipating fans 3 together define a cycling air channel. The heat generated by the light sources 5 during operation is absorbed by the heat sinks 21. Furthermore, air currents are introduced by the heat dissipating fans 3 into and flow through the air guiding channels 22 to proceed with heat exchange, so that the heat generated by the light sources 5 can be carried to the environment by the air currents. Thus, the hot air currents will not circulate inside the LCD 4, providing enhanced heat dissipating effect and prolonging the service life of the light sources 5.

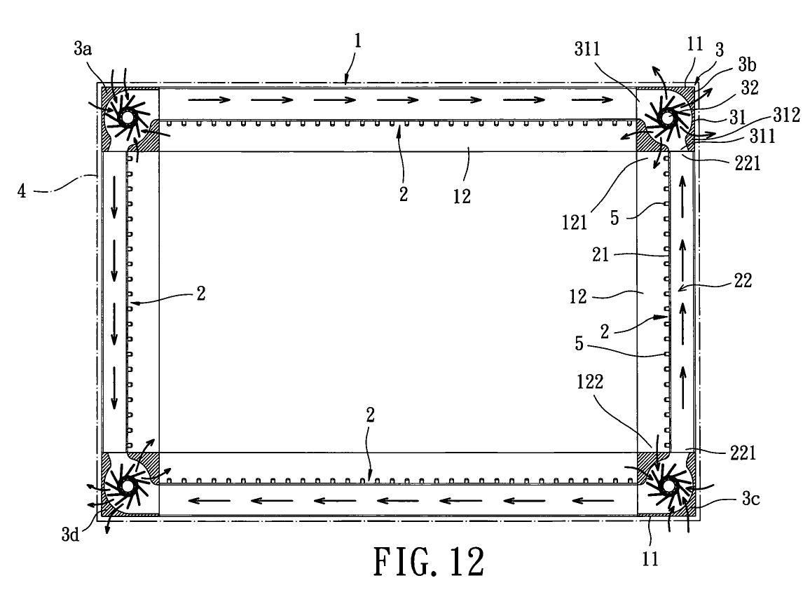

The heat dissipating device according to the teachings of the present invention achieves a plurality of heat dissipating mechanisms and advantages by selectively utilizing blower type heat dissipating fans or axial-flow type heat dissipating fans. To facilitate explanation of some of the heat dissipating mechanisms, the heat dissipating fans 3 of the heat dissipating device according to the teachings of the present invention are labeled as first, second, third, and fourth heat dissipating fans 3 in FIG. 12.

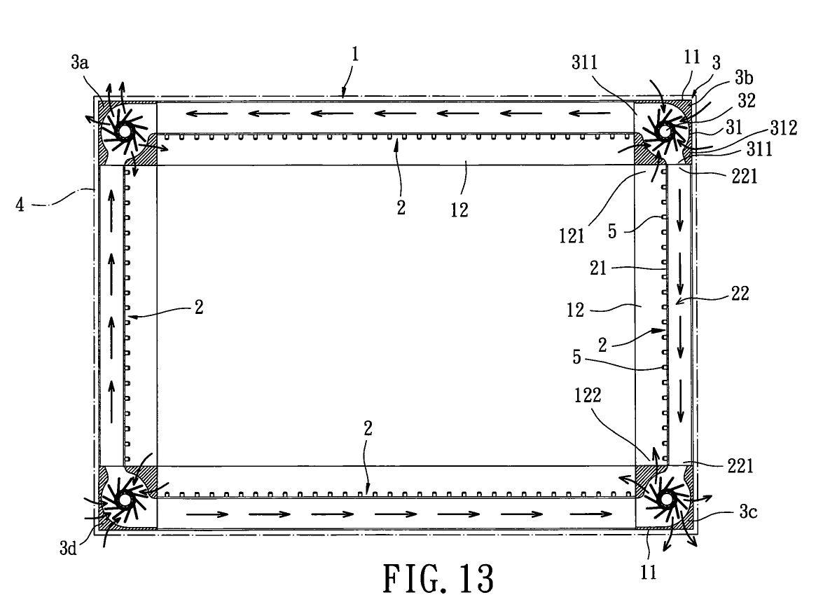

Specifically, in use of the preferred form shown in FIGS. 5 and 12 utilizing blower type heat dissipating fans 3, the heat dissipating fans 3 can operate alternately to prolong the service life of the heat dissipating fans 3. In an example, the first and third heat dissipating fans 3a and 3c operate simultaneously while the second and fourth heat dissipating fans 3b and 3d are inoperative. The air guiding hole 311 of the upper cover 313 of each of the first and third heat dissipating fans 3a and 3c serves as an air inlet allowing ambient air to be introduced into the housings 31 of the first and third heat dissipating fans 3a and 3c. The air guiding holes 311 of the lateral wall 312 of each of the first and third heat dissipating fans 3a and 3c serve as air outlets, so that the air currents can pass through the air outlets into the air guiding channels 22 of the associated air-guiding members 2. The heat generated by the light sources 5 can be carried to the second and fourth heat dissipating fans 3b and 3d by the air currents flowing through the air guiding channels 22. Since the second and fourth heat dissipating fans 3b and 3d are inoperative, the hot air currents can pass through the air guiding holes 311 of the second and fourth heat dissipating fans 3b and 3d to the environment. After a time period that can be set by the user according to needs, the first and third heat dissipating fans 3a and 3c are stopped, and the second and fourth heat dissipating fans 3b and 3d begin to operate to perform the heat dissipating mechanism (FIG. 13). Thus, the same heat dissipating effect can be achieved by alternately operating the heat dissipating fans 3 while avoiding damage to the heat dissipating fans 3 due to long-term operation.

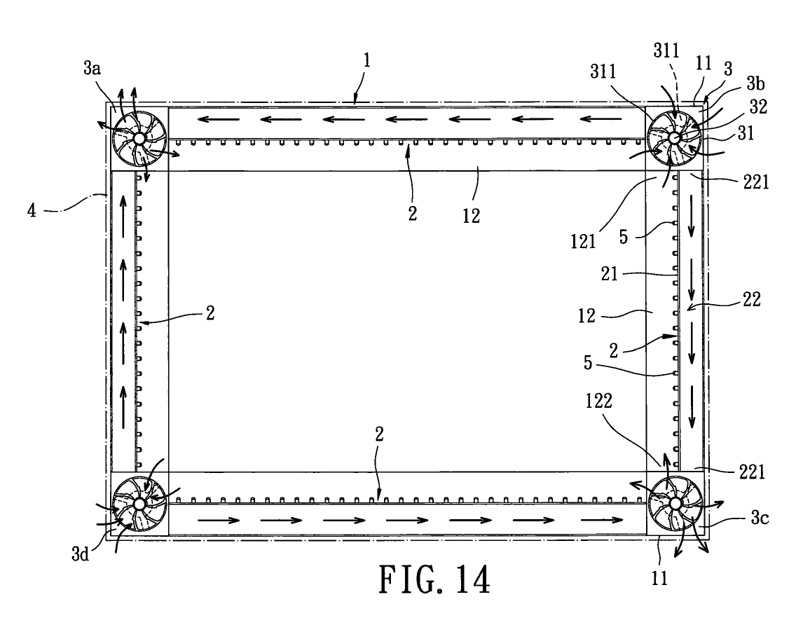

In use of the preferred form shown in FIGS. 6 and 14 utilizing axial-flow type heat dissipating fans 3, the heat dissipating fans 3 can operate simultaneously when the light sources 5 are liable to overheat during operation. As an example, the impellers 32 of the first and third heat dissipating fans 3a and 3c rotate in a clockwise direction to introduce the ambient air into the associated air guiding channels 22. Furthermore, the impellers 32 of the second and fourth heat dissipating fans 3b and 3d rotate in a counterclockwise direction to rapidly drive and guide the air currents in the air guiding channels 22 to the environment. Thus, damage to the light sources 5 due to overheat can be effectively avoided while providing enhanced heat dissipating effect.

In a case that dust accumulates in the air guiding holes 311 of the heat dissipating fans 3, the heat dissipating fans 3 can be controlled to rotate in a reverse direction. Due to the characteristics of the axial-flow type heat dissipating fans 3, the dust accumulated in the air guiding holes 311 can be removed by the air currents while the impellers 32 rotate in the reverse direction, avoiding the air guiding holes 311 from being blocked by the dust.

In a case that one of the heat dissipating fans 3 is damaged, the other undamaged heat dissipating fans 3 can still operate or rotate at a higher speed to avoid damage to the light sources 5 due to overheat.

According to the above, the heating dissipating device according to the teachings of the present invention utilizes the heat dissipating fans 3 cooperating with the cycling air channel formed by the air guiding channels 22 of the air-guiding members 2 to proceed heat dissipation of the light sources 5 of the lighting module. Furthermore, the air currents can flow through the air guiding channels 22 to effectively lower the temperature of the light sources 5 on each heat sink 21 by controlling the heat dissipating mechanisms through alternate operations of the heat dissipating fans 3, providing more heat dissipating functions and achieving enhanced heat dissipating effect.

Compared to the conventional heat dissipating device 8, the heat sink 82 occupying a larger area is not required in the heat dissipating device according to the teachings of the present invention. Particularly, the heat dissipating fans 3 and the air-guiding members 2 utilized in the heat dissipating device according to the teachings of the present invention do not occupy a large space while achieving the required heat dissipating effect, allowing easy installation and miniaturization of the lighting module.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A heat dissipating device for a lighting module comprising:
a frame including a plurality of assembling portions and a plurality of connecting portions, with each of the assembling portions interconnected between two adjacent connecting portions, with each of the connecting portions including first and second ends, with each of the first and second ends of each of the connecting portions interconnected to an adjacent assembling portion;
a plurality of air-guiding members each mounted on a side of one of the plurality of connecting portions, with the plurality of air-guiding members on a same side of the frame, with each of the air-guiding members including an air guiding channel in a side thereof and extending from the first end through the second end of one of the plurality of connecting portions, with each of the air guiding channels including two ends each having an opening; and
a plurality of heat dissipating fans each mounted to one of the plurality of assembling portions of the frame and located between two adjacent openings respectively of two adjacent air-guiding members, with each of the heat dissipating fans including a first air guiding hole in communication with an environment and at least one second air guiding hole in communication with the two adjacent openings,
with the air guiding channels of the plurality of air-guiding members and the plurality of heat dissipating fans together forming a cycling air channel.

2. The heat dissipating device as claimed in claim 1, with each of the heat dissipating fans including a housing and an impeller rotatably mounted in the housing, with each of the heat dissipating fans including two second air guiding holes in communication with the two adjacent openings, with the housing including a lateral wall having said two second air guiding holes, and with an upper cover mounted to the lateral wall and including the first air guiding hole.

3. The heat dissipating device as claimed in claim 2, with said two second air guiding holes having different sizes.

4. The heat dissipating device as claimed in claim 1, with each of the heat dissipating fans including a housing and an impeller rotatably mounted in the housing about a rotating axis, with each of the heat dissipating fans including a second air guiding hole spaced from the first air guiding hole along the rotating axis of the impeller.

5. The heat dissipating device as claimed in claim 4, with the housing of each of the heat dissipating fans and one of the assembling portions of the frame together forming an air passageway.

6. The heat dissipating device as claimed in claim 1, with each of the air-guiding members including a plurality of fins located in the air guiding channel of the air-guiding member.

7. The heat dissipating device as claimed in claim 6, with the plurality of fins extending perpendicularly to the heat sink.

8. The heat dissipating device as claimed in claim 1, with each of the air-guiding members further including a closure member coupled to the heat sink to seal the air guiding channel.

9. The heat dissipating device as claimed in claim 1, with each of the assembling portions of the frame including an outer wall, and with each of the heat dissipating fans abutting with the outer wall of one of the assembling portions.
